(19) United States
(12) Patent Application Publication
(10) Pub. No.: US 2026/0178483 A1
(43) Pub. Date: Jun. 25, 2026

(54) METHOD AND APPARATUS FOR ACCELERATING KV-SEPARATED LSM-TREE STORAGE INDEXING BASED ON SMART SSD

(71) Applicant: HUAZHONG UNIVERSITY OF SCIENCE AND TECHNOLOGY, Wuhan (CN)

(72) Inventors: Haikun LIU, Wuhan (CN); Zhuohui DUAN, Wuhan (CN); Hao FENG, Wuhan (CN); Xiaofei LIAO, Wuhan (CN); Hai JIN, Wuhan (CN)

(21) Appl. No.: 19/302,307

(22) Filed: Aug. 18, 2025

(30) Foreign Application Priority Data
Dec. 23, 2024 (CN) 2024119055989

(51) Int. Cl. G06F 12/02

(52) U.S. Cl. CPC G06F 12/0246; G06F 2212/7205

(57) ABSTRACT

A method and apparatus for accelerating KV-separated LSM-tree storage indexing based on smart SSD are disclosed. The method comprises: constructing, on a host side, a KV-separated LSM-tree storage module comprising a GC manager and a GC scheduler, wherein GC manager constructs and manages a ValidMap to record KV data validity at respective positions in a value file, and GC scheduler is configured to initiate, schedule, and write back results of GC compute units; constructing GC compute units on a smart SSD side to offload a garbage collection module from the host side, the GC compute units performing garbage collection via decoding, processing, and encoding without data dependencies; and determining a parameter configuration for the number of deployed GC compute units meeting throughput requirements. The present application offloads garbage collection to a smart SSD architecture, avoiding conflicts with read/write operations, efficiently utilizing hardware resources, and enabling coordinated software-hardware state management.

### BACKGROUND OF THE APPLICATION

### 1. Technical Field

The present disclosure relates to the field of computer technology, and more particularly to a method for accelerating KV-separated LSM-tree storage indexing based on smart SSD and an apparatus for implementing such a method.

### 2. Description of Related Art

In the age of big data, storage technology faces unprecedented challenges. The surge in data volume has rendered existing storage systems unable to meet increasingly demanding performance requirements. In such a context, key-value storage systems based on LSM trees (Log-Structured Merge-trees) have become a research hotspot due to their excellent write performance. Particularly for processing large value data, LSM trees with key-value (KV) separation significantly reduce data storage space by storing keys and values separately and replacing actual value data with a value address index. This effectively mitigates read/write amplification during data compaction. However, this architecture suffers from the accumulation of stale data. Existing garbage collection (GC) mechanisms determine data validity by scanning value files and querying LSM trees, filtering out invalid values, and writing valid values back, significantly impacting system performance. When stale data accumulates to a certain threshold, frequent GC triggering causes a sharp drop in system throughput. Further, a conservative GC strategy may reduce I/O contention but increases CPU computational burden, as data encoding/decoding, verification, and merging are CPU-intensive operations.

Near data processing (NDP) provides a new solution to these issues. By offloading computational tasks to storage, NDP architectures can reduce CPU usage, free bus bandwidth, and minimize data movement overheads. A smart SSD (Solid State Drive), as a commercialized NDP hardware representative, enables its internal compute units to directly access data in the storage medium without navigating complex operating system storage stacks or interconnect buses. However, current GC mechanism optimizations usually face the challenge of balancing data capacity and computational performance, requiring trade-offs between computational and read/write overheads. No research has yet addressed GC mechanisms bottlenecks using near-data architecture. Smart tasks offloading could overcome limitations in host resources, request latency, and energy consumption, offering a promising solution. Yet, in a smart SSD, simple task offloading is insufficient due to computational environment differences, necessitating targeted processing in task context, resource management, data movement, and the like.

To sum up, the existing art's deficiencies include a sharp drop in system throughput due to GC mechanisms and the trade-off between computation and storage optimization.

CN118550474A discloses a separated key-value (KV) pair storage system comprising a host side and a storage side, wherein the host side remotely accesses the storage side via an RDMA network. The host side receives a user's read request and searches for a target key-value pair. If not found, it modifies an NVMe read instruction by filling the high 32 bits and low 32 bits of the key-value pair offset value into the NVMe read instruction and sends it to the storage side. The storage side then parses TFilter metadata in the NVMe read instruction to locate the target KV pair, searches for it in SGE, and modifies the SGE's starting address and length based on the TFilter metadata to filter out non-target KV pairs. The target KV pair is sent to the host side as the SGE. This system reduces network traffic overhead by filtering before transmission, improving transmission rates. However, it fails to address GC mechanism bottlenecks or balance between computation and storage optimization.

It is the objective of the present disclosure to provide a method and apparatus for accelerating KV-separated LSM-tree storage indexing based on smart SSD to reduce the impact of GC on system performance and balance computation and storage optimization.

Note that, due to potential discrepancies in understanding among those skilled in the art, and because the applicant reviewed extensive literature and patents during the development of this disclosure, not all details are listed due to space constraints. This does not imply that the present disclosure lacks prior art features; rather, it encompasses all relevant prior art features. The applicant reserves the right to supplement this application with further details and features from related existing art, as appropriate, in accordance with relevant regulations.

### SUMMARY OF THE APPLICATION

Existing technical solutions cannot reduce the computational burden of GC mechanisms on the smart SSD side. Due to NAND flash characteristics, data must be erased before writing, with erasure performed in blocks, generating invalid data during deletion or overwriting. The GC process involves copying valid data to blank pages in different zones, erasing all data units in the current data zone, and writing new data to the recently erased zone. This process significantly impacts the smart SSD side's read/write performance and service life. During GC process, a tradeoff between computational and read/write overheads is required. High GC overheads degrade smart SSD performance and affect its lifespan. The smart SSD side's compute units differ from the existing computing environments, requiring not simple task transplantation but a deep understanding of its specific environment and limitations, along with customized solutions.

To address the deficiencies of the prior art, the present disclosure provides a method for accelerating KV-separated LSM-tree storage indexing based on smart SSD, comprising: constructing, on a host side, a KV-separated LSM-tree storage module, the KV-separated LSM-tree storage module comprising a GC manager and a GC scheduler, wherein the GC manager constructs and manages a ValidMap to record the validity of KV data at respective positions in a value file, and the GC scheduler is configured to initiate, schedule, and write back results of GC compute units; constructing the GC compute units on a smart SSD side to offload a garbage collection module from the host side to the smart SSD side, the GC compute units performing garbage collection on the smart SSD side in a manner of decoding, processing, and encoding without data dependencies among them; and determining a parameter configuration for the number of deployed GC compute units that meets throughput requirements.

The smart SSD side has independent computational power, enabling GC task handling without interfering with host side resources. Thus, offloading GC operations to the smart SSD side effectively releases I/O and CPU resources. By leveraging the smart SSD side's parallel processing, the present disclosure reduces the host side's I/O and CPU burdens, enhancing GC efficiency and minimizing system resource consumption.

In a preferred embodiment, the method of the present disclosure further includes: having the GC compute unit decode a value file to be garbage collected and its corresponding ValidMap, and combine the value file's KV data with the ValidMap's validity status to generate a character stream containing the KV data with validity status. Based on the offloading approach, GC management and scheduling strategies are designed to prevent conflicts between GC and read/write operations, efficiently utilize the hardware resources on the smart SSD side, and enable synergistic software-hardware management, fully leveraging hardware offloading advantages.

In a preferred embodiment, the processing step of the GC compute unit includes: traversing the decoded character stream in the form of a data stream, determining a write/read type based on the ValidMap's validity status, and filtering out invalid KV data.

By performing GC on the smart SSD side with an effective scheduling strategy, the GC process is separated from read/write operations, reducing task resource competition and enabling efficient resource utilization. This scheduling strategy prevents interruption of read/write operations during GC process, ensuring overall system performance. The smart SSD side's resources are utilized more effectively, with software-hardware synergy optimized through scheduling strategies.

In a preferred embodiment, the encoding step of the GC compute unit includes: generating a new value file from unfiltered KV data and writing it back to the SSD, and rewriting metadata to the KV-separated LSM-tree storage module.

The smart SSD side's ability to handle data writeback enables the GC process to operate independently of the host side's I/O operations, avoiding excessive network and CPU resource usage. Thus, the host side's I/O burden is reduced, as GC computation and write tasks are completed on the smart SSD side without frequent data transmission.

In a preferred embodiment, the method of the present disclosure further includes: having the GC manager collect staleness information of key-value pairs during data compaction to construct or update the ValidMap; and having the GC scheduler collect garbage collection data, determine hardware activation timing, and activate the smart SSD side's GC compute unit to complete the write-back of GC results.

The synergistic operation of the GC manager and scheduler enables accurate resource use determination and coordination, reducing operational conflicts and enhancing the efficiency of the smart SSD side. Their coordination balances the GC process and data access, optimizing the timing of GC activation to enable better hardware resource utilization.

In a preferred embodiment, the GC scheduler's execution step includes: calculating the number of idle GC compute units and the allocation of available FPGA memory; reading value files to the GC compute units through internal pathways between the SSD and the field programmable gate array (FPGA), and reading the ValidMap to the GC compute units via a PCIe bus between the host side and the smart SSD side; activating the GC compute units and waiting for completion of garbage collection processes; and writing back the results to the KV-separated LSM-tree storage module.

Reasonable partitioning of FPGA memory and optimized data transmission over the PCIe bus maximize the throughput of GC compute units, fully utilizing performance the smart SSD side's hardware constraints. This method, through effective field programmable gate array (FPGA) and FPGA memory management, optimizes data transmission paths and resource allocation, further enhancing system efficiency and throughput.

As a second aspect, the present disclosure provides an apparatus for accelerating KV-separated LSM-tree storage indexing based on smart SSD, comprising a smart SSD side and a host side, wherein the smart SSD side is in communication with the host side. A KV-separated LSM-tree storage module is constructed on the host side, wherein the KV-separated LSM-tree storage module includes a GC manager and a GC scheduler. The GC manager constructs and manages a ValidMap to record the validity of KV data at respective positions in a value file, and the GC scheduler is configured to initiate, schedule, and write back results of GC compute units. Besides, GC compute units are constructed on the smart SSD side to offload a garbage collection module from the host side to the smart SSD side, wherein the GC compute units perform garbage collection on the smart SSD side in a manner of decoding, processing, and encoding without data dependencies among them. Furthermore, a parameter configuration for the number of deployed GC compute units that meets throughput requirements will be determined.

Constructing GC compute units on the smart SSD side enables offloading of the GC module from the host side to the smart SSD side. These GC compute units perform decoding, processing, and encoding on the smart SSD side without data dependencies, addressing I/O and CPU bottlenecks during the GC process. By performing GC tasks solely on the smart SSD side, the system reduces the host side's burden, enhances GC operations efficiency, and optimizes resource utilization.

The apparatus of the present disclosure, by performing GC tasks on the smart SSD side, reduces data transmission over the bus between the host and SSD, thereby improving data processing concurrency and efficiency.

In a preferred embodiment, the GC compute unit is configured to: decode a value file to be garbage collected and its corresponding ValidMap, and combine the value file's KV data with the ValidMap's validity status to generate a character stream containing the KV data with validity status.

This step ensures identification of valid and invalid data during the GC process, optimizing the GC process, improving system performance, and reducing storage and computational overheads caused by invalid data. By performing decoding and state combination directly on the smart SSD side, the frequency of data transmission between the host side and the smart SSD side is significantly decreased, minimizing transmission delay and bandwidth requirements.

In a preferred embodiment, the GC compute unit is further configured to: traverse the decoded character stream in the form of a data stream, determine a write/read type based on the ValidMap's validity status, and filter out invalid KV data.

By filtering out invalid data, the GC process reduces unnecessary data processing and storage, thereby improving system efficiency and performance while ensuring data validity. By performing invalid data filtering on the smart SSD side, the amount of data transmitted to the host side is significantly reduced, optimizing the data transmission path and accelerating data processing.

In a preferred embodiment, the GC compute unit is further configured to: generate a new value file from unfiltered KV data and write it back to the SSD, and rewrite metadata to the KV-separated LSM-tree storage module. This configuration ensures data integrity and consistency after the GC process and maintains correct system operation by updating metadata. By performing data writeback and metadata updates directly on the smart SSD side, the frequency of external data transmission and data processing time are reduced, further improving system response speed.

### BRIEF DESCRIPTION OF THE DRAWINGS

FIG. 1 is a schematic diagram of module connection in an apparatus for accelerating KV-separated LSM-tree storage indexing based on smart SSD according to the present disclosure;

FIG. 2 is a logical diagram of a method for accelerating KV-separated LSM-tree storage indexing based on smart SSD according to the present disclosure;

FIG. 3 is a structural diagram of a GC compute unit according to the present disclosure;

FIG. 4 is a computational flowchart of GC task offloading according to the present disclosure;

FIG. 5 is a schematic diagram of the operation logic of a GC scheduler according to the present disclosure;

FIG. 6 is a schematic diagram of the operation logic of a GC manager according to the present disclosure; and

FIG. 7 is a flowchart of processing a read/write request according to the present disclosure.

### DETAILED DESCRIPTION OF THE APPLICATION

The present disclosure will be described in detail with reference to the accompanying drawings.

Some terms used in this disclosure are defined as follows.

KV separation (Key-Value Separation) is a storage optimization technology commonly used in KV databases. By storing keys and values separately, it enhances system performance and resource utilization. Keys, typically small and frequently accessed, are stored in fast-access media such as memory, while values, larger and frequently updated, are stored on slower disks. The KV separation method reduces memory usage and write amplification, thereby improving overall performance and response speed of the system.

In KV-separated LSM-tree storage, GC (Garbage Collection) is a file management module that cleans invalid data to enhance storage efficiency. Its primary function is to release storage space occupied by numerous invalid key-value data generated during data insertion, updating, and deletion, reducing I/O operations to improve storage system performance. By identifying stale, invalid KV data in a value file, the GC module safely releases the occupied SSD storage space, simplifying file management for developers and enhancing program robustness and stability. However, the GC process may temporarily impact system performance, as it may pause normal program execution in some cases to ensure operational consistency between the memory and external storage.

A smart SSD (Solid State Drive) is a solid-state storage device that integrates processing capabilities, enabling direct data processing within the storage medium without relying on the CPU on the host side. Equipped with a dedicated hardware accelerator field-programmable gate array (FPGA), a smart SSD performs computations on data stored internally, reducing data transmission delay and bandwidth consumption. Utilizing a Near Data Processing (NDP) architecture, the smart SSD significantly reduces the host side's computational burden and optimizes overall system performance, making it suitable for big-data processing, real-time analysis, and high-performance computing. The smart SSD side refers to an electronic device equipped with a smart SSD.

An FPGA (Field-Programmable Gate Array) is an integrated circuit configurable by a user on-site using a hardware description language (e.g., VHDL or Verilog). Comprising an array of programmable logic units, an FPGA implements complex digital computational logics. With flexible configuration, it is suitable for various applications, including digital signal processing, real-time data processing, and custom compute accelerators. An FPGA offers advantages over an application-specific integrated circuit (ASIC) in design cycle and flexibility, as its functions can be reprogrammed at the hardware level.

FPGA memory refers to storage resources integrated within an FPGA memory chip, supporting temporary data storage and fast access for logic circuits. An FPGA memory chip typically includes on-chip random-access memory (RAM), read-only memory (ROM), block RAM (BRAM), and distributed RAM. It provides essential storage space for complex computation and data processing, supporting implementations from simple buffer data and look-up tables to complex state machines and caches. This highly configurable memory enhances the FPGA's performance and adaptability in handling various tasks and algorithms.

An SSD controller is the core component of a smart SSD, managing and coordinating read/write operations of data within the smart SSD. It acts as a bridge between the host side and the NAND flash chip, employing complex firmware algorithms to perform tasks such as error correction, garbage collection, wear leveling, and data encryption. The SSD controller's performance and efficiency directly affect the SSD's speed, reliability, and lifespan, ensuring efficient data layout and transmission among storage blocks to optimize overall performance.

ANAND chip is a non-volatile storage component in a smart SSD for storing data. NAND flash memory stores data in blocks, featuring high density and low costs making it ideal for high-capacity storage applications. It uses an array of electronic units to store bit data, including SLCs (single-level cells), MHLCs (multi-level cells), TLCs (triple-level cells), and QLCs (quad-level cells), each with distinct performance, durability, and cost. The NAND chip's properties directly determine the smart SSD's storage capacity, durability, and data-processing speed.

A GC manager (Garbage Collection Manager) is a component or module that manages and executes the GC process. Typically used in storage systems, particularly in KV-separated LSM tree storage systems, the GC manager identifies, recycles, and releases storage space no longer referenced by the program, enabling the system to reuse these resources. Through automated GC processes, it minimizes redundant space occupancy and reduces the complexity of manual file management, enhancing software stability and efficiency.

A GC scheduler (Garbage Collection Scheduler) is a component or a module that arranges and optimizes the GC process. In file management, it determines the timing and frequency of GC to minimize its impact on application performance. By analyzing the system's redundant space occupancy ratio, program execution states, and resource availability, the GC scheduler intelligently coordinates GC execution timing. An effective GC scheduler ensures efficient storage resource utilization and timely recycling while maintaining system performance.

A GC compute unit (Garbage Collection Compute Unit) refers to the component that performs computationally intensive operations during the GC process. These operations include identifying stale, invalid data, arranging and compacting data, and updating memory references. The GC compute unit aims to effectively execute GC operations, minimizing their impact on applications performance. By optimizing these computationally intensive tasks, the GC compute unit enhances GC process efficiency, thereby improving overall system performance and responsiveness.

The host side includes a CPU and DRAM. The program operating the KV-separated LSM-tree storage module runs on the host side's CPU and DRAM. The CPU processes all computational operations, including read/write of KV pairs, data compaction, file read/write, and GC. System data structures, such as MemTables, are cached in memory. Preferably, the host side may be a server or a server cluster. Additionally, preferably, the host side may be implemented by an application-specific integrated circuit chip with equivalent computational and operational capabilities.

A ValidMap is a data structure that indicates which data entries or memory regions are valid. It is applicable to various scenarios. In memory management, a ValidMap indicates which memory addresses are allocated and available. In the GC mechanism, it identifies objects still referenced, requiring retention rather than recycling. In a data cache system, a ValidMap determines which cached data are current or valid, preventing the use of stale information. While implementations and uses of a ValidMap across systems, its core function is to represent data validity and status through a mapping structure.

### Embodiment 1

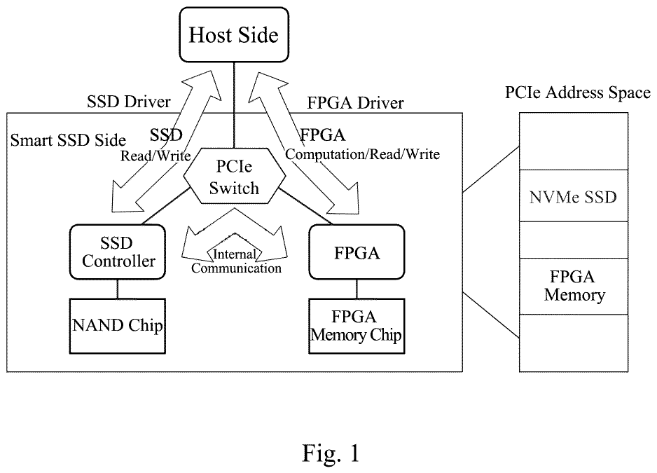

The present disclosure provides an apparatus for accelerating KV-separated LSM-tree storage indexing based on smart SSD, which includes a host side and a smart SSD side. As shown in FIG. 1, the smart SSD side and the host side are connected via a PCIe (Peripheral Component Interconnect Express) bus, offering high bandwidth and low latency for rapid data transmission therebetween. Specifically, the smart SSD on the smart SSD side connects to the host side's motherboard through a PCIe slot, which provides electrical connection and physical fixation, ensuring stable communication therebetween. Data transmission between the smart SSD side and the host side uses a PCIe protocol, defining packet format, transmission methods, and error handling mechanisms, ensuring accurate data transmission.

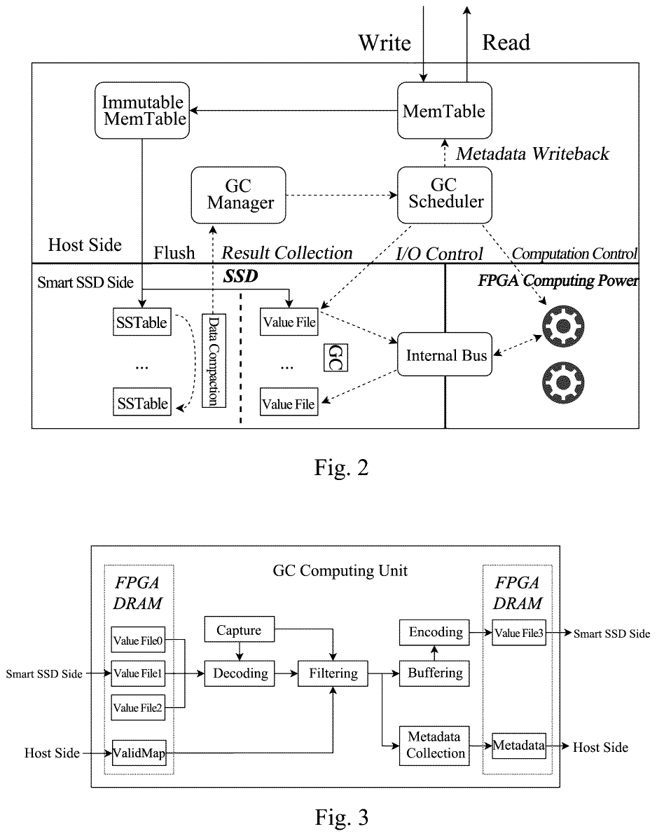

Preferably, as shown in FIGS. 1 and 2, the smart SSD includes an SSD and FPGA. The SSD provides large-capacity data storage. As shown in FIG. 1, the SSD includes an SSD controller and a NAND chip as the storage medium, mutually connected to enable the SSD controller to manage data read/write operations. The FPGA and SSD are connected to and communicate with each other via internal wiring, enabling synergistic operation to enhance data processing efficiency. In the smart SSD, the FPGA may implement various functions, such as data processing, encryption, and compaction. Specifically, the SSD handles data read/write operations, while the FPGA performs real-time data processing and computation. The SSD further includes driver programs for the SSD and FPGA.

The smart SSD side includes a PCIe interface. The SSD and FPGA are connected to the PCIe interface on the smart SSD side, enabling high-speed data transmission to support the computational requests of the SSD and FPGA. The SSD and FPGA are mapped to distinct PCIe address spaces (as shown in FIG. 1), allowing them to independently handle the SSD's read/write requests and the FPGA's computational requests within the system's PCIe architecture.

Preferably, when the host side sends a read/write request to the smart SSD side, it transmits request data containing information such as the target address and data length to the smart SSD side using the corresponding PCIe address. The SSD controller on the smart SSD side receives the request data via a PCIe switch, parses and evaluates its contents, and then performs the corresponding operation according to the request type. For a read request, the SSD controller reads data from the SSD, and sends it to the host side via the PCIe bus. For a write request, the SSD controller writes data from the host side to the NAND chip, and sends a response signal to the host side after completing the write operation.

As shown in FIG. 1, when the host side sends a read/write request to the SSD side, it transmits a compute request to the SSD device driver (also known as SSD driver). The SSD driver encapsulates control information for the compute request to ensure format and protocol compatibility with the smart SSD side. Upon receiving the computation/read/write request, the SSD controller on the smart SSD side assigns and schedules tasks according to the request's type and priority, then uses the programmable logic circuit of the corresponding FPGA to perform computations according to the request's instructions and. The FPGA includes an FPGA memory chip.

As shown in FIG. 2, the apparatus of the present disclosure includes the host side and the smart SSD side.

The host side includes a MemTable and an immutable MemTable of the KV-separated LSM-tree storage module, as well as the GC manager and GC scheduler disclosed herein. The MemTable caches KV data from write requests received by the apparatus, and when full, converts to an immutable MemTable, which is flushed and written to the SSD on the smart SSD side. The MemTable also supports reading KV data. The GC manager collects and maintains a ValidMap structure from the result of SSTable data compaction, a process merging multiple smaller SSTables into a larger SSTable to optimize query performance and storage efficiency. The immutable MemTable is continuously flushed. The GC scheduler executes GC operations, reading the corresponding ValidMap from the GC manager to transmit the ValidMap to the FPGA's GC compute units, synchronously transmitting value files via the I/O control unit, activating the GC compute units via the compute control unit for data processing, and writing back the resulting metadata to the MemTable. Preferably, the FPGA provides computational power, referring to its computational capability.

The smart SSD side includes an SSD and FPGA. The SSD stores key files (i.e., SSTables) and value files. The host side's GC manager continuously performs data compaction on key files and GC on value files to organize data and maintain storage space stability. Multiple GC compute units are deployed in the FPGA to offload GC operations originally executed in the KV-separated LSM-tree storage on the host side. Under the control of the GC scheduler's I/O control unit on the host side, the FPGA's memory data and the SSD's file storage data are transmitted via the internal bus channel of the smart SSD side.

This configuration enables the smart SSD side to perform GC computations, allowing offloading of the GC process from the KV-separated LSM-tree storage module. GC tasks are then extracted from the host side's context, and file transmission is prepared via internal pathways of the smart SSD side. The smart SSD side completes GC computations and writes back the corresponding result (i.e., the metadata). This process is supported and controlled by the host side's GC manager and GC scheduler.

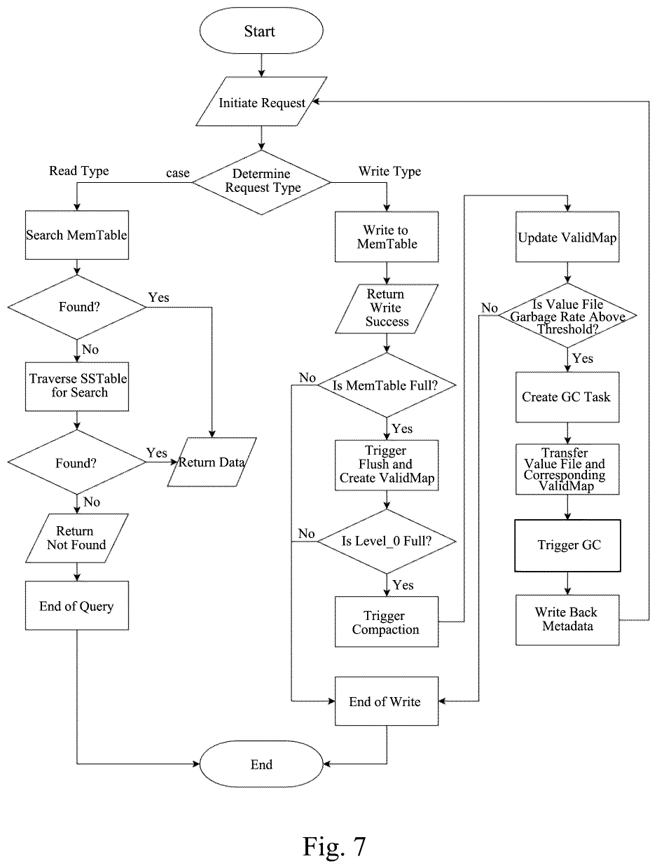

The KV-separated LSM-tree storage module on the smart SSD side processes read/write requests via steps illustrated in FIG. 7.

### Step S000: Start.

Step S101: When the apparatus comprising the host side and the smart SSD side is activated, the KV-separated LSM-tree storage module configures parameters to create related resources. Specifically, according to the number of currently idle GC compute units, it activates the required FPGA and GC compute unit instances on the smart SSD side.

Step S102: Initiate request.

After activation, the KV-separated LSM-tree storage module receives requests initiated by an external system or user, which may be read or write operations.

Step S103: Determine request type.

The KV-separated LSM-tree storage module identifies the request type as either a write or read request. For a read request, proceed to S104; for a write request, proceed to S109.

Step S104: For a read request, the KV-separated LSM-tree storage module searches the MemTable for the required data.

Step S105: Determine if the required data is found. If found, return the data and end the process.

Step S106: If the required data is not found, the KV-separated LSM-tree storage module traverses SSTables for further search.

Step S107: If the required data is found in an SSTable, return the data and end the process.

Step S108: If the required data is not found in SSTables, return a “not found” and end the query.

Step S109: For a write request, the KV-separated LSM-tree storage module writes the data to the MemTable.

Step S110: Return a “write successful” message.

Step S111: Check if the MemTable is full by verifying if its capacity has reached the limit. If yes, proceed to S112; otherwise, proceed to S113 (write operation ends).

Step S112: If yes, trigger a Flush operation to write data from the MemTable to disk as an SSTable file (i.e., Level 0 in LSM) and create a ValidMap for the new SSTable, then proceed to S114.

Step S113: Write operation ends.

Step S114: Check if Level_0 is full.

After the Flush operation, verify if the Level_0 capacity has reached its threshold. If yes, proceed to S115; otherwise, proceed to S113.

Step S115: If yes, trigger data compaction.

### Step S116: Update the ValidMap.

Upon completing data compaction, the GC manager updates the ValidMap to reflect the current data validity status.

Step S117: The GC manager checks if the garbage rate of the value file reaches the threshold (i.e., garbage rate threshold). If yes, proceed to S118; otherwise, proceed to S113.

Step S118: If the threshold is reached, create a GC task and issue it to the GC scheduler.

Step S119: Transmit value files and the corresponding ValidMap.

Upon receiving the new GC task, the GC scheduler's compute control unit creates a hardware GC offload task context, and the I/O control unit transmits all value files and the corresponding ValidMap to the GC compute units.

Step S120: Trigger GC (at GC compute unit).

The GC compute unit initiates the GC computation process and awaits completion.

Step S121: Write back metadata.

Upon task completion by the GC compute unit, the metadata write-back unit in the GC manager receives the returned GC metadata and writes all metadata back to the KV-separated LSM-tree storage module via batched write requests.

Preferably, the GC compute unit's offloading process for GC task includes three stages: input decoding, data computation, and output encoding.

In the input decoding stage, the GC compute unit processes value files subject to GC and their corresponding ValidMap. As shown in FIG. 3, an FPGA DRAM in the FPGA memory chip reads the value files to be processed, including Value File 0, Value File 1, Value File 2, . . . , and the ValidMap provided by the host side. KV pairs within a value file are adjacent. The GC compute unit determines offset boundaries according to data size, and the ValidMap is then encoded with standardized character data for efficient retrieval of marker bit information at corresponding positions. This enables the GC compute unit to perform a highly parallelized pipelined decoding process on the target files.

In the data computation stage, the GC compute unit traverses character streams as data streams based on the ValidMap for filtering, generating signals for removal or retention. During iterative loops, the GC compute unit captures decoded KV data at the current offset and the filtering signals. If the signal indicates retention, the KV data is buffered, and its metadata (such as size and offset position) are collected. If the signal indicates removal, as stale data need not be copied or migrated, the KV data is skipped, and the process loops to the next data.

In the output encoding stage, the GC compute unit re-encodes all buffered KV data in their original order to generate Value File 3, filling the KV data according to the value file format and setting the file header, then writing Value File 3 back to the SSD via the smart SSD side's internal bus. Metadata collection occurs during the data computation stage, including metadata for each KV data, supplemented by computed metadata such as key-value count, file size, and old/new addresses and size of KV data. All metadata from the completed GC task are transmitted to the host side's GC scheduler metadata write-back unit via the PCIe bus.

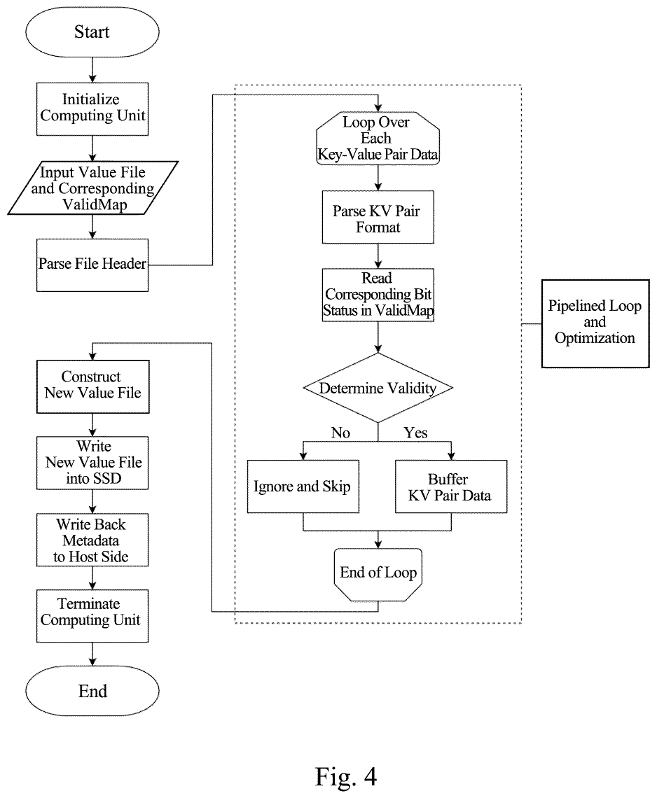

As shown in FIG. 4, the GC compute unit offloads GC tasks through the following steps:

Step S000: Start.

Step S210: In the initialization stage, initialize the GC compute unit, input value files and the corresponding ValidMap, and parse the file header.

Specifically, initialize memory spaces, load the internal communication library and modules of the smart SSD side to ensure the GC compute unit is ready.

The GC compute unit receives the value files and the corresponding ValidMap as inputs for the GC task. It parses the file header of the value files to extract key information, such as file format version, compaction format, and file size, to facilitate subsequent data processing.

Step S220: In the processing stage, iteratively process each KV pair, parse its format, and read the corresponding bit state from the ValidMap. Specifically, the GC compute unit processes each KV pair in a loop.

For each KV pair, it first parses the format to determine the lengths of the key and value for accurate read and processing.

Then, according to the position of the current KV pair, it reads the corresponding bit state from the ValidMap to determine whether the KV pair is valid.

If invalid, the KV pair is skipped, and the loop proceeds to the next KV pair. If valid, the KV pair is buffered, and the loop ends, awaiting subsequent encoding.

Throughout the process, pipelined loops and optimization techniques can be employed for parallel processing to enhance data processing efficiency. For example, parsing KV pair formats, reading ValidMap bit states, and determining validity can be performed concurrently for multiple KV pairs to increase throughput.

Step S230: In the final stage, construct a new value file from the buffered KV data, write the new value file to the SSD, write back metadata to the host side, and terminate the GC compute unit.

Specifically, the GC compute unit reads all buffered KV pairs from the KV data buffer, reconstructs a new value file in the value file format, and writes it to the SSD via internal pathways.

After processing all KV pairs, the GC compute unit writes the metadata (e.g., new addresses of migrated KV data and basic information of the new value file) back to the metadata write-back unit of the GC scheduler on the host side. Upon completing all data processing and write-back operations, the GC compute unit is closed, and occupied resources, such as memory and file handles, are released.

Step S240: End.

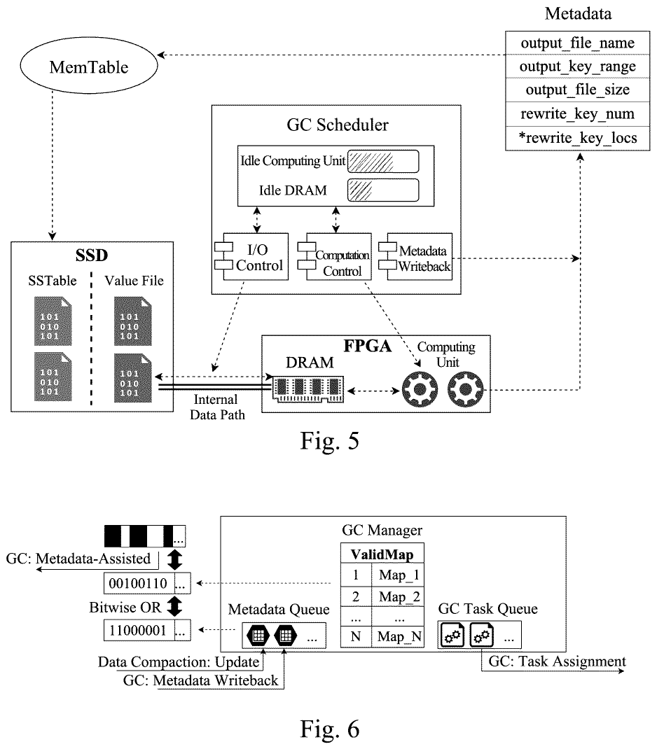

As shown in FIG. 5, the execution process of the GC scheduler includes the following steps:

As shown in FIG. 5, the GC scheduler includes an I/O control unit, a compute control unit, and a metadata write-back unit. The I/O control unit manages the FPGA to utilize internal pathways between the SSD and FPGA for preparing and writing back GC data. The compute control unit interfaces with the GC compute units in the FPGA for data connection and process control. Metadata generated by the GC compute units are input to the metadata write-back unit, which writes them to the MemTable on the host side, subsequently persisting them to the SSD during the host side's Flush operation.

(1) The I/O control unit handles data preparation and result write-back when idle GC compute units and DRAM are available. Specifically, a GC compute unit requires input value files and a ValidMap, and outputs a new value file and metadata for a garbage collection task. Under the I/O control unit's control, the FPGA performs read and write-back operations for value files via internal data pathways of the smart SSD side. The ValidMap and metadata write-back are transmitted via the system bus between the host side and the smart SSD side. Additionally, the I/O control unit employs hardware-based asynchronous instruction allocation and transmission to enhance read/write parallelism between pathways and tasks while preventing concurrency errors.

(2) The compute control unit schedules GC compute units. The number of compute units in the hardware is determined by GC parameters specified at system runtime. FPGA memory chip usage is allocated and managed according to the number of active compute units and the FPGA DRAM quota per unit. The theoretical minimum memory size for each compute unit includes space for input files, reserved output files, and temporary intermediate computation values. The compute control unit also manages the start and termination of GC compute units using an asynchronous waiting mechanism. Upon completion, a callback function is triggered to transfer results data to the metadata write-back unit.

(3) The metadata write-back unit writes the GC compute unit's results back to the KV-separated LSM-tree storage module, including basic information of the new value file (e.g., filename, key range, size, and data volume) and new addresses of migrated KV data. This information is collected during GC compute unit execution and transmitted to the metadata write-back unit.

The GC manager includes a ValidMap maintenance submodule and a GC information collection submodule.

As shown in FIG. 6, the ValidMap is based on a bitmap structure, using a single bit to indicate the validity of data at each offset point. Each value file corresponds to one ValidMap. The memory space for all ValidMaps is uniformly registered or destroyed by the host side's dynamic memory management interface. The ValidMap maintenance submodule manages and reads ValidMaps in memory. By monitoring the validity ratio of each value file's ValidMap, when the garbage rate threshold is exceeded, the GC manager publishes a GC task in the metadata queue and assigns it to the GC scheduler for subsequent processing. During task transmission to the GC scheduler, the ValidMap corresponding to the value file under the GC process is read and transmitted to the GC scheduler, either through transposition or metadata-assisted methods. Metadata assistance refers to auxiliary information provided by metadata during garbage collection and validity management, enabling efficient identification of invalid data for recycling and valid data for retention. Transposition refers to the rearrangement or repositioning of data or metadata in memory to optimize memory usage, enhance access efficiency, or organize data.

Data compaction is performed for updates. The GC information collection submodule collects location information of all filtered data, transmitted via callback after each data compaction. Upon receiving aggregate location data for invalid data, the GC initiates an update process, traversing the invalid data. Preferably, the GC manager reconstructs temporary ValidMaps using file numbers and offset orders from invalid data, then performs a bitwise OR operation between each temporary ValidMap and the corresponding ValidMap in global space to update the data structure.

Then the metadata are written back. After a GC operation, deleted files are transmitted to the GC manager. Upon receiving metadata containing filenames, the GC manager deletes the corresponding ValidMaps.

With a systematic parameter configuration, the method of the present disclosure maximizes the utilization of the FPGA hardware resources on the smart SSD side. Due to limited resources on the smart SSD side, only a finite number of compute units can be deployed, and DRAM resources must support the data demands of each GC compute unit. Increasing the number of compute units to enhance throughput must consider resource constraints. Since the computational performance of GC compute units is determined at compilation, real-time monitoring of the apparatus's throughput for external requests, combined with theoretical modeling of GC compute unit throughput, provides guidance for GC parameter settings in various read/write mixed scenarios.

Step S310: To determine GC-related parameters, first collect current workflow characteristics and hardware resources quotas to provide essential data for subsequent calculations.

Specifically, workflow characteristics include the total throughput required for processing external read/write requests and the proportion of request types. Hardware resources quotas refer to the FPGA computational power on the smart SSD side (including CLB, FF, and LUT) and the resources required for deploying each GC compute unit.

Step S320: The trigger condition for a GC task is a file garbage rate exceeding a threshold. In a stable state (where the redundant space ratio in value file remains stable while the apparatus continuously receives read/write requests), the following equation must be satisfied to ensure stable storage space utilization:

$${Th}_{updade} \leq {\sum }_{i = 1}^{{N}_{C U}} {Th}_{i} * Gr ,$$

where Th_{update} represents the throughput of KV pair update or deletion requests across the apparatus, Thᵢ represents the throughput of each GC compute unit, N_{CU} represents the number of deployed GC compute units, and Gr represents the garbage rate threshold for triggering GC. The system throughput before GC is the theoretical upper limit of the current configuration. Hardware-offloaded GC compute units impose minimal system burden, and when their total garbage recycling throughput matches the system's garbage generation rate, storage redundancy remains stable without degrading performance.

For example, with a default Gr of 0.5 (indicating GC is triggered when invalid data exceeds 50%), an update request throughput of 30,000 requests/sec, and a GC compute units throughput of 15,000 requests/sec, the minimum number of required GC compute units is calculated as 4.

Step S330: The equation requires solving the theoretical throughput of each compute unit. The computation method is as follows: the total time for a GC task includes the time for data reading, compute execution, data writing, and metadata write-back.

The throughput of a GC compute unit is defined as the quotient of the total data processed in a task divided by the total time consumed, satisfying the following equation:

$${Th}_{i} = \frac{{N}_{sum}}{{T}_{read} + {T}_{compute} + {T}_{write} + {T}_{meta}} ,$$

where Thᵢ is the theoretical throughput of a GC compute unit, Nₛᵤₘ is the total data processed in a GC task, and Tread, T_{compute}, T_{write}, and Tₘₑₜₐ represent the times for data reading, compute execution, data writing, and metadata write-back, respectively.

Step S340: Hardware resources for each GC compute unit, including CLB (Configurable Logic Blocks), FF (Flip Flop), and LUT (Lookup Table), are determined at compilation. When compiling and deploying GC compute units using the Vitis module, the automatically generated resource usage report details all hardware resource consumption. Based on these requirements, the maximum number of GC compute units deployable in a single smart SSD is determined by:

$${N}_{CU} \leq min ( \frac{{R}_{CLB}}{{N}_{CLB}} , \frac{{R}_{FF}}{{N}_{FF}} , \frac{{R}_{LUT}}{{N}_{LUT}} ) ,$$

where R_{CLB}, R_{FF}, and R_{LUT} represent the CLB, FF, and LUT resources quotas of the FPGA in a single smart SSD, and N_{CLB}, N_{FF}, and N_{LUT} represent the resources required by a single GC compute unit. The actual number of deployed GC compute units (N_{CU}) must not exceed the smart SSD's resource limits.

Step S350: Combining the stable storage space utilization condition from S320, the throughput calculation method from S330, and the resource constraints from S340, the parameter configuration for storage space redundancy (Gr) and the number of deployed GC compute units (N_{CU}) is determined to meet the apparatus's read/write throughput requirements, enabling the KV-separated LSM-tree storage module to operate with these parameters.

For example, with 300,000 KV data inputs per GC task, completion times of 2 seconds for data reading, 12 seconds for data computation, 2 seconds for data writing, and 4 seconds for metadata write-back (total 20 seconds), the GC compute unit's throughput is 15,000 entries/sec. With an FPGA in the smart SSD having 70,000 CLBs, 500,000 FFs, and 1,000,000 LUTs, and a single compute unit requiring 8,000 CLBs, 20,000 FFs, and 30,000 LUTs, the maximum N_{CU} is 8. Given an update request throughput of 30,000 requests/sec, the minimum required N_{CU} is 4 (within the limit of 8).

### Embodiment 2

This embodiment further refines Embodiment 1, with repetitive content omitted.

For large-scale e-commerce platforms, data updates and writes are frequent, and the data storage structure is dynamically updated (e.g., product information updates, user behavior logging, and transaction order management). The storage engine's performance determines the platform's ability to provide high-quality, stable services.

The method and apparatus of the present disclosure can be applied to e-commerce platforms to optimize data processing efficiency, with the following steps:

### (1) KV-Separated LSM-Tree Storage

In an e-commerce platform, large volumes of data are stored as key-value pairs in the KV-separated LSM-tree storage module. For instance, user behavior logs are crucial for analyzing user behavior, optimizing user experience, and enabling targeted marketing. When users perform actions such as browsing products, searching, adding items to carts, or placing orders, the system generates real-time user behavior logs containing unique user identifiers (e.g., user ID), behavior types (e.g., browsing, searching, cart addition), timestamps, and related product information. Using the KV-separated LSM-tree storage module, a log entry's key may be a unique identifier, such as a string combining user ID, behavior type, and timestamp, while the value includes detailed behavior information, such as product ID or search keywords. In this KV-separated storage approach, keys are stored in the module's index files, and values are stored in separate data file regions, enabling rapid value location via key indexing to enhance query and access efficiency.

### (2) Smart-SSD-Based Acceleration Method

On an e-commerce platform, extensive key-value pair data, such as product information, user data, and order records, require real-time writing and updating. For example, when User A browses, searches, or transacts, or when Product B is listed, delisted, or reconfigured, existing KV pairs become stale, necessitating continuous garbage collection to handle expired data promptly. By leveraging the KV-separated LSM-tree storage module built on the smart SSD side, the GC compute units non-intrusively address the accumulation of expired data in the value region, preventing read/write performance degradation due to the need for efficient stale data processing.

Applying the method and the apparatus of the present disclosure to an e-commerce platform provides the following advantages:

First, it resolves I/O and CPU bottlenecks. Offloading GC operations from the host side to the smart SSD side leverages high-speed in-memory computational power and high-bandwidth internal buses to reduce I/O operations, mitigating CPU bottlenecks caused by garbage collection. This ensures stable performance of the e-commerce platform during high-concurrency data read/write scenarios, such as mass order placements or product queries during promotions.

Second, it enhances computational performance. The hardware GC compute units on the smart SSD side execute GC in three stages, namely decoding, computing, and encoding, with highly parallelized pipeline optimization. Compared to existing CPU processing, this significantly reduces computation time for data encoding/decoding, verification, and merging, thereby improving overall system performance.

Third, it enables efficient hardware resource management. Systematic parameter configuration provides optimal GC parameter recommendations based on the platform's workflow characteristics, hardware resources quotas, and performance targets. For instance, rationally setting the GC trigger threshold and the number of compute units ensures stable storage redundancy without compromising performance, while efficiently utilizing smart SSD hardware resources.

Fourth, it optimizes resource utilization. The GC scheduler's I/O control unit uses internal smart SSD data pathways for parallel read/write operations, avoiding concurrency errors. The GC compute unit allocates the compute units and FPGA DRAM quotas rationally to enhance resource utilization. The metadata write-back unit employs queue buffering and batch flushing to coordinate GC result write-back, minimizing performance impact and fully leveraging smart SSD hardware resources for e-commerce data storage.

It should be noted that the above embodiments are exemplary. Those skilled in the art, inspired by the present disclosure, may devise various solutions within the scope of the present disclosure and its protection. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, indicated by terms like “preferably” or “according to a preferred embodiment”, each representing a distinct concept disclosed in the respective paragraph. The applicant reserves the right to file divisional applications based on each inventive concept.

What is claimed is:

1. A method for accelerating KV-separated LSM-tree storage indexing based on smart SSD, the method comprising:
constructing, on a host side, a KV-separated LSM-tree storage module, the KV-separated LSM-tree storage module comprising a GC manager and a GC scheduler, wherein
the GC manager constructs and manages a ValidMap to record the validity of KV data at respective positions in a value file, and
the GC scheduler is configured to initiate, schedule, and write back results of GC compute units;
constructing the GC compute units on a smart SSD side to offload a garbage collection module from the host side to the smart SSD side, the GC compute units performing garbage collection on the smart SSD side in a manner of decoding, processing, and encoding without data dependencies among them; and
determining a parameter configuration for the number of deployed GC compute units that meets throughput requirements.

2. The method of claim 1, further comprising:
having the GC compute unit decode the value file to be garbage collected and the ValidMap corresponding to the value file, and combine the KV data of the value file with the validity status of the ValidMap to generate a character stream containing the KV data with the validity status.

3. The method of claim 2, wherein the processing step of the GC compute unit includes:
traversing the character stream obtained through decoding in the form of a data stream, determining write/read type based on the validity status of the ValidMap, and filtering out invalid KV data.

4. The method of claim 3, wherein the encoding step of the GC compute unit includes:
generating a new value file from the unfiltered KV data and writing it back to the SSD, and rewriting metadata to the KV-separated LSM-tree storage module.

5. The method of claim 4, further comprising:
having the GC manager collect staleness information of the KV pairs during data compaction to construct or update the ValidMap, and
having the GC scheduler collect garbage collection data, determine the hardware wake-up timing, and activate the GC compute unit on the smart SSD side to complete the write-back of GC results.

6. The method of claim 5, wherein the execution step of the GC scheduler includes:
calculating the number of idle GC compute units and the allocation of available FPGA memory;
reading the value files to the GC compute units through internal pathways between the SSD and the FPGA memory, and reading the ValidMap to the GC compute units via a PCIe bus between the host side and the smart SSD side;
activating the GC compute units and waiting for completion of garbage collection processes, and
writing back the results of the garbage collection process to the KV-separated LSM-tree storage module.

7. The method of claim 6, further comprising:
upon startup of the apparatus comprising the host side and the smart SSD side, having the KV-separated LSM-tree storage module configure parameters to create corresponding resources.

8. The method of claim 7, further comprising:
making the KV-separated LSM-tree storage module activate the required field programmable gate array (FPGA) and GC compute unit instances on the smart SSD side according to the current number of idle GC compute units.

9. The method of claim 8, further comprising:
after startup is completed, enabling the KV-separated LSM-tree storage module to receive requests initiated by an external system or a user, wherein the requests are read operations or write operations.

10. The method of claim 9, further comprising:
making the KV-separated LSM-tree storage module determine the type of the request;
in the case of a read type request, performing a MemTable lookup;
in the case of a write type request, writing the data into the MemTable.

11. An apparatus for accelerating KV-separated LSM-tree storage indexing based on smart SSD, the apparatus comprising a smart SSD side and a host side, wherein the smart SSD side is in communication with the host side, and
constructing, on the host side, a KV-separated LSM-tree storage module, the KV-separated LSM-tree storage module comprising a GC manager and a GC scheduler, wherein
the GC manager constructs and manages a ValidMap to record the validity of KV data at respective positions in a value file, and
the GC scheduler is configured to initiate, schedule, and write back results of GC compute units;
constructing GC compute units on the smart SSD side to offload a garbage collection module from the host side to the smart SSD side, the GC compute units performing garbage collection on the smart SSD side in a manner of decoding, processing, and encoding without data dependencies among them; and
determining a parameter configuration for the number of deployed GC compute units that meets throughput requirements.

12. The apparatus of claim 11, wherein the GC compute unit is configured to:
decode the value file to be garbage collected and the ValidMap corresponding to the value file, and
combine the KV data of the value file with the validity status of the ValidMap to generate a character stream containing the KV data with the validity status.

13. The apparatus of claim 12, wherein the GC compute unit is further configured to: traverse the character stream obtained through decoding in the form of a data stream, determine a write/read type based on the validity status of the ValidMap, and filter out invalid KV data.

14. The apparatus of claim 13, wherein the GC compute unit is further configured to: generate a new value file from the unfiltered KV data and write it back to the SSD, and re-write metadata to the KV-separated LSM-tree storage module.

15. The apparatus of claim 14, wherein:
the GC manager is configured to collect staleness information of KV pairs during data compaction to construct or update the ValidMap, and
the GC scheduler is configured to collect garbage collection data, determine the hardware wake-up timing, and activate the GC compute unit on the smart SSD side to complete the write-back of GC results.

16. The apparatus of claim 15, wherein the GC scheduler is configured to:
calculate the number of idle GC compute units and the allocation of available FPGA memory;
read the value files to the GC compute units through internal pathways between the SSD and the field programmable gate array (FPGA), and read the ValidMap to the GC compute units via a PCIe bus between the host side and the smart SSD side;
activate the GC compute units and wait for completion of garbage collection process; and
write back the results of the garbage collection process to the KV-separated LSM-tree storage module.

17. The apparatus of claim 16, wherein the apparatus is configured to:
upon startup of the apparatus comprising the host side and the smart SSD side, have the KV-separated LSM-tree storage module configure parameters to create corresponding resources.

18. The apparatus of claim 17, wherein the apparatus is configured to:
make the KV-separated LSM-tree storage module activate the required field programmable gate array (FPGA) and GC compute unit instances on the smart SSD side according to the current number of idle GC compute units.

19. The apparatus of claim 18, wherein the apparatus is configured to:
after startup is completed, enable the KV-separated LSM-tree storage module to receive requests initiated by an external system or a user, wherein the requests are read operations or write operations.

20. The apparatus of claim 19, wherein the apparatus is configured to:
have the KV-separated LSM-tree storage module determine the type of the request;
in the case of a read type request, perform a MemTable lookup;
in the case of a write type request, write the data into the MemTable.
